(19) United States
(12) Patent Application Publication
(10) Pub. No.: US 2026/0310967 A1
(43) Pub. Date: Oct. 8, 2026

(54) METHOD AND SYSTEM FOR PREDICTING GENERATED POWER OF NEW ENERGY STATION BASED ON RECURRENT GRAPH NEURAL NETWORK

(71) Applicants: STATE GRID HUNAN ELECTRIC POWER COMPANY LIMITED, Hunan (CN); STATE GRID HUNAN ELECTRIC POWER COMPANY LIMITED RESEARCH INSTITUTE, Hunan (CN); STATE GRID CORPORATION OF CHINA, Beijing (CN)

(72) Inventors: Ding WANG, Hunan (CN); Yuanhang DAI, Hunan (CN); Shu ZHU, Hunan (CN); Qiang LUO, Hunan (CN); Min XU, Hunan (CN); Meng XIANG, Hunan (CN); Liqiang PAN, Hunan (CN); Hao CHEN, Hunan (CN); Yabing YAN, Hunan (CN); Guangming ZHU, Hunan (CN); Tao WAN, Hunan (CN); Li LI, Hunan (CN); Ting CUI, Hunan (CN); Jinbo WU, Hunan (CN); Linyi CHEN, Hunan (CN); Qiang SHI, Hunan (CN)

(21) Appl. No.: 19/537,759

(22) Filed: Feb. 12, 2026

Related U.S. Application Data
(63) Continuation of application No. PCT/CN2025/146024, filed on Dec. 26, 2025.

(30) Foreign Application Priority Data
Apr. 7, 2025 (CN) 202510427493.5

(51) Int. Cl. G06N 3/084

(52) U.S. Cl. CPC G06N 3/084

(57) ABSTRACT

Provided are a method and system for predicting the generated power of the new energy station based on the recurrent graph neural network. The method includes the following: A graph neural network model is pre-constructed, where the graph neural network model includes a graph neural network layer, a recurrent neural network layer, and a first full-connection layer; the historical weather forecast data of a target station, the actual power data of the target station, the historical weather forecast data of a source domain station, and the actual power data of the source domain station are acquired, and the graph neural network model is trained based on the historical weather forecast data of the source domain station and the actual power data of the source domain station to obtain a trained graph neural network model.

### CROSS-REFERENCE TO RELATED APPLICATION(S)

This is a continuation of International Patent Application No. PCT/CN2025/146024, filed on Dec. 26, 2025, which is based on and claims priority to Chinese Patent Application No. 202510427493.5 filed with the China National Intellectual Property Administration (CNIPA) on Apr. 7, 2025, the disclosures of which are incorporated herein by reference in their entireties.

### TECHNICAL FIELD

The present application mainly relates to the field of new energy technology, for example, a method and system for predicting generated power of a new energy station based on a recurrent graph neural network.

### BACKGROUND

With the increasingly widespread application of a new energy power (primarily photovoltaic and wind power) generation system, more and more new energy stations are being integrated into a distribution network, which poses significant challenges to the planning, operation, control, and other aspects of the power system. Due to the close correlation between output features of new energy stations and meteorological conditions, the new energy power generation systems inherently exhibit stochastic and fluctuating output power. In the short term, the mismatch between power storage facilities and grid-integrated new energy power is difficult to resolve. Consequently, the large-scale integration of the new energy power generation system into the power grid can impose substantial impacts on the safe and stable operation of the power system. This also represents a key technical issue that must be addressed for the large-scale integration of new energy power generation into the power grid. Countries around the world have successively conducted technical research on the prediction of the generated power of new energy, holding significant importance for the stable operation of the power systems and helping a power system dispatching department coordinate the power generation planning of conventional energy and new energy and reasonably arrange the operation manner of the power grid.

Currently, models used for predicting the generated power of new energy stations are mostly machine learning models and deep learning models. In the related art, a model for predicting the generated power of a new energy station constructs a mapping relationship from forecast meteorological data, historical meteorological data, and historical generated power data to the actual generated power of a power plant and uses the mapping relationship for predicting the generated power of the new energy station in a future period of time. Moreover, the method in the related art is mainly data-driven, with the model extracting the mapping relationship from forecast meteorology, historical meteorology, and historical generated power to actual generated power from data. In a conventional scenario, at least one year of historical data is expected to be used to train the model. However, for newly operational stations, there may be cases of historical data less than one year, or even as short as one or two months.

To guarantee the prediction performance of the model, for a station with less than one year of historical data or even only one or two months of historical data, a common approach is to combine the data of a surrounding station with the data of a target station for model training. That is, the number of samples is increased. Alternatively, the model is trained based on the historical data of the surrounding station (a source domain station) and then migrated to the target station for fine-tuning to perform subsequent power prediction. Here, the target station refers to a station to be configured with a power prediction model, and the surrounding station is the source domain station. Currently, only one source domain station is used in the method for training the model for the target station based on data fusion or model migration. Therefore, before model training, data analysis and station screening need to be performed for the surrounding station. Even if the data of one surrounding station is selected for data fusion or the model is trained based on migration mechanisms, the data of other surrounding stations is often wasted.

### SUMMARY

The present application provides a method and system for predicting the generated power of a new energy station based on a recurrent graph neural network so as to train a model with relatively little training cost, improving training efficiency and guaranteeing relatively high prediction accuracy.

The technical solutions provided in the present application are as below.

A method for predicting the generated power of a new energy station based on a recurrent graph neural network is provided. The method includes the following.

A graph neural network model is pre-constructed. The graph neural network model includes a graph neural network layer, a recurrent neural network layer, and a first full-connection layer. The graph neural network layer, the recurrent neural network layer, and the first full-connection layer are sequentially connected to each other.

Historical weather forecast data of a target station, actual power data of the target station, historical weather forecast data of a source domain station, and actual power data of the source domain station are acquired; and the graph neural network model is trained based on the historical weather forecast data of the source domain station and the actual power data of the source domain station to obtain a trained graph neural network model; where the source domain station is a surrounding station of the target station.

A parameter weight of each network layer in the trained graph neural network model is frozen and migrated to the target station to obtain a power prediction model, and then the power prediction model is fine-tuned based on historical meteorological data of the target station and the actual power data of the target station to obtain a final power prediction model for predicting power of the target station.

In an embodiment, that the parameter weight of the each network layer in the trained graph neural network model is frozen and migrated to the target station includes the following.

A distance between stations is determined according to longitude and latitude coordinates of the target station.

The target station is incorporated as a new node into the graph neural network layer of the graph neural network model, and an edge connection state between the target station and the existing source domain station is determined based on the distance between the stations.

A second full-connection layer is added based on the graph neural network model to obtain the power prediction model.

In an embodiment, that the power prediction model is fine-tuned based on the historical meteorological data of the target station and the actual power data of the target station includes the following.

The historical meteorological data of the target station and the actual power data of the target station are copied (n+1) times to be input into a graph neural network layer of the power prediction model and a recurrent neural network layer of the power prediction model to obtain an output result of the recurrent neural network layer, where a data dimension of the historical weather forecast data of the target station and a data dimension of the actual power data of the target station are [bs, n+1, T, d], where bs denotes a data batch size, n+1 denotes a number of stations, T denotes a length of sequence data, and d denotes a number of features of input data.

The output result of the recurrent neural network layer is merged to obtain data with a dimension of [bs*(n+1), T, d2], the dimension of the data is changed to [bs*(n+1)*T, d2], and then the changed data having the dimension of [bs*(n+1)*T, d2] is input into the first full-connection layer FC1 to obtain data with a dimension of [bs*(n+1)*T, 1].

The data with the output dimension of [bs*(n+1)*T, 1] is changed to data with a dimension of [bs*T, n+1], and the changed data having the dimension of [bs*T, n+1] is input into the second full-connection layer FC2 to obtain data with a dimension of [bs*T, 1].

The dimension of tag data is changed to [bs*T], MSE loss is calculated based on tag data and the data with the dimension of [bs*T, 1].

In an embodiment, that the historical meteorological data of the target station and the actual power data of the target station are copied (n+1) times to be input into the graph neural network layer of the power prediction model and the recurrent neural network layer of the power prediction model to obtain the output result of the recurrent neural network layer includes the following.

The operations below are performed for each time step in which t=1, 2, . . . , and T.

Slice data with a dimension of [bs, n+1, d] is sliced into the graph neural network layer GCN2 to obtain an output with a dimension of [bs, n+1, d1], where d1 is determined by an output channel parameter of the graph neural network layer.

The output dimension [bs, n+1, d1] is changed to [bs*(n+1), d1] to be input into the recurrent neural network layer to obtain data with a dimension of [bs*(n+1), d2], where d2 is determined by a parameter of the recurrent neural network layer RNN.

In response to a current time step t<=T, preceding operations are repeated and the time step is increased by 1; and in response to t>T, a next step is proceeded to.

In an embodiment, that the graph neural network model is trained based on the historical weather forecast data of the source domain station and the actual power data of the source domain station includes the following.

The source domain station is selected and the distance between the stations is determined according to longitude and latitude coordinates of the stations, edge connection state between nodes in the graph neural network layer is determined based on the selected source domain station, a number of layers in the graph neural network layer and a parameter of the graph neural network layer are determined, and a number of layers in the recurrent neural network layer and a parameter of the recurrent neural network layer are determined.

Historical meteorological data of the source domain station and the actual power data of the source domain station are input into the graph neural network layer and the recurrent neural network layer to obtain an output result of the recurrent neural network layer, where a data dimension of the historical meteorological data of the source domain station and a data dimension of the actual power data of the source domain station are [bs, n, T, d], where bs denotes a data batch size, n denotes the number of source domain stations, T denotes a length of sequence data, and d denotes the number of features of input data.

The output result of the recurrent neural network layer is merged to obtain data with a dimension of [bs*n, T, d2], the dimension of the data is changed to [bs*n*T, d2], and then the changed data having the dimension of [bs*n*T, d2] is input into the first full-connection layer FC1 to obtain data with a dimension of [bs*n*T, 1].

The dimension of tag data is changed to [bs*n*T], MSE loss is calculated based on tag data and the data with the dimension of [bs*n*T, 1].

In an embodiment, that the historical meteorological data of the source domain station and the actual power data of the source domain station are inputted into the graph neural network layer and the recurrent neural network layer to obtain the output result of the recurrent neural network layer includes the following.

The operations below are performed for each time step in which t=1, 2, . . . , and T.

Slice data with a dimension of [bs, n, d] is input into the graph neural network layer GCN1 to obtain an output with a dimension of [bs, n, d1], where d1 is determined by an output channel parameter of the graph neural network layer.

The output dimension [bs, n, d1] is changed to [bs*n, d1] to be input into the recurrent neural network layer RNN to obtain data with a dimension of [bs*n, d2], where d2 is determined by a parameter of the recurrent neural network layer RNN.

In response to a current time step t<=T, preceding operations are repeated and the time step is increased by 1; and in response to t>T, a next step is proceeded to.

In an embodiment, weather forecast data includes forecast irradiance, forecast temperature, forecast humidity, forecast air pressure, forecast wind speed, and forecast wind direction.

The present application also discloses a computer program product including a computer program. When the computer program is executed by a processor, steps of the preceding method are performed.

The present application also discloses a computer-readable storage medium for storing a computer program which, when executed by a processor, performs steps of the preceding method.

The present application further discloses a system for predicting the generated power of a new energy station based on a recurrent graph neural network, including a memory and a processor connected to each other. The memory stores a computer program. The computer program, when executed by the processor, performs steps of the preceding method.

The advantages of the present application are as below.

In the method for predicting new energy power in the present application, a composite architecture fusing the graph neural network layer (GNN layer) and the recurrent neural network layer (RNN layer) is used. The GNN layer captures the spatial synergistic features of a regional meteorological field through a topological connection to model the spatial correlation (such as meteorological transmission or geographic proximity effect) between stations. The RNN layer dynamically models time sequence data and analyzes the time-varying laws of meteorological factors such as wind speed and irradiance. The dual-network coupling implements the joint analysis of spatio-temporal dependency in the meteorology-power mapping relationship and improves prediction accuracy. In the migration stage of the present application, GNN-RNN core parameters are frozen (with spatial topology modeling and time sequence feature extraction capabilities retained), and only full-connection layers are fine-tuned to adapt to features of the target station (such as the inclination angle of a photovoltaic panel and a difference between wind turbine models), resulting in a low training cost and improving training efficiency.

### BRIEF DESCRIPTION OF DRAWINGS

FIG. 1 is a structural diagram of a graph neural network layer according to the present application.

FIG. 2 is a structural diagram of a graph neural network model according to the present application.

FIG. 3 is a structural diagram of a power prediction model according to the present application.

FIG. 4 is a flowchart of a method for training the graph neural network model according to the present application.

FIG. 5 is a flowchart of a method for training the power prediction model according to the present application.

FIG. 6 is an edge connection matrix corresponding to FIG. 1.

FIG. 7 is a structural diagram after a target station is incorporated as a new node into the existing graph neural network layer according to the present application.

FIG. 8 is an edge connection matrix corresponding to FIG. 7.

FIG. 9 is a flowchart of a method for predicting the generated power of a new energy station based on a recurrent graph neural network according to the present application.

### DETAILED DESCRIPTION

The present application is described below in conjunction with the drawings and embodiments.

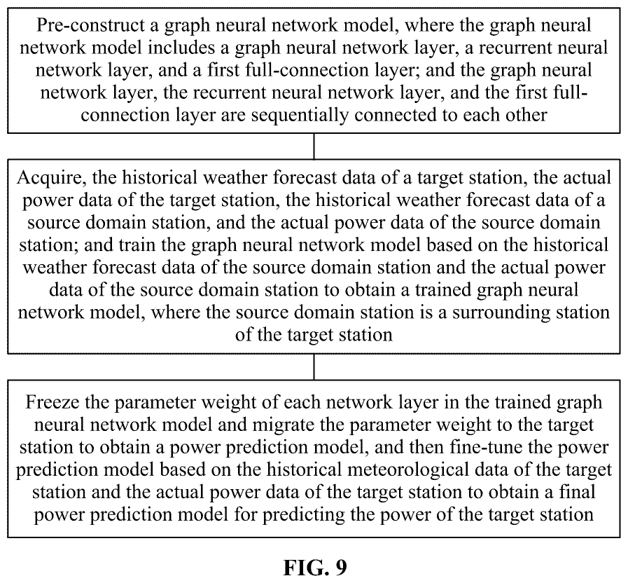

As shown in FIG. 9, an embodiment of the present application provides a method for predicting the generated power of a new energy station based on a recurrent graph neural network according to the present application. The method includes the steps below.

A graph neural network model is pre-constructed. The graph neural network model includes a graph neural network layer, a recurrent neural network layer, and a first full-connection layer. The graph neural network layer, the recurrent neural network layer, and the first full-connection layer are sequentially connected to each other.

The historical weather forecast data of a target station, the actual power data of the target station, the historical weather forecast data of a source domain station, and the actual power data of the source domain station are acquired; and the graph neural network model is trained based on the historical weather forecast data of the source domain station and the actual power data of the source domain station to obtain a trained graph neural network model. The source domain station is a surrounding station of the target station.

The parameter weight of each network layer in the trained graph neural network model is frozen and migrated to the target station to obtain a power prediction model, and then the power prediction model is fine-tuned based on the historical meteorological data of the target station and the actual power data of the target station to obtain a final power prediction model for predicting the power of the target station.

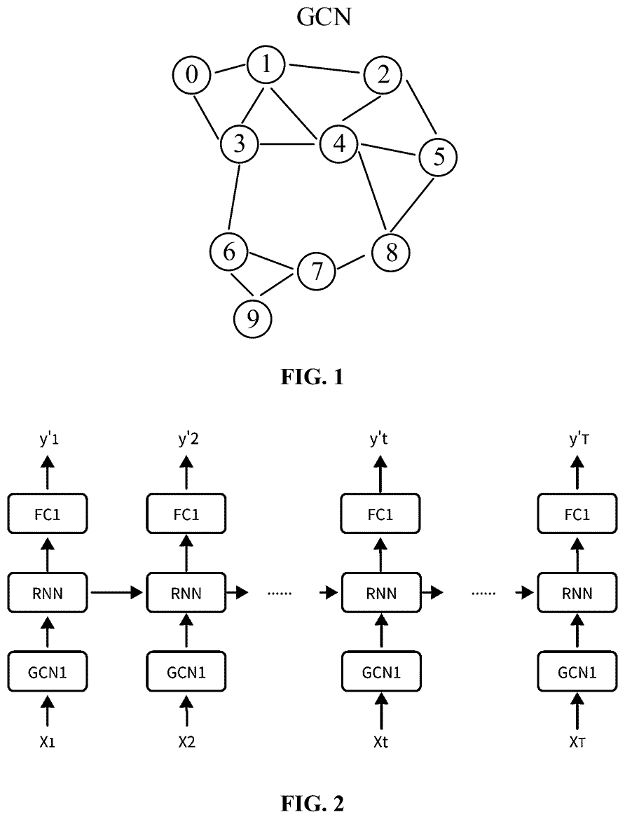

Exemplarily, each of historical weather forecast data and actual power data is sequence data with a dimension of (X¹, . . . , Xⁿ)∈ [symbol] . Xⁱ∈ [symbol] denotes the sequence data. n denotes the number of stations. T denotes the length of the sequence data. d denotes the number of input features. The actual power corresponding to the input data is (labeled as) (y¹, . . . , yⁿ)∈ [symbol] For each observation moment in which t=1, 2, . . . , and T, slice data Xₜ∈ [symbol] is taken. An observation moment may be understood as the n-th moment in the sequence data. Then the slice data Xₜ is represented by one graph neural network layer and corresponds to actual power yₜ∈ [symbol] . FIG. 1 shows a graph neural network layer (GCN) composed of 10 stations, with each node representing one station. The feature of each node in the graph neural network layer is weather forecast data and historical measurement data Xₜ∈ [symbol] . Whether a connection exists between stations depends on the distance between stations. For example, if the distance between two stations is less than kilometers, the two stations are connected to each other.

As shown in FIG. 2, the time slice data processed by the graph neural network layer is input into the recurrent neural network layer (RNN) and finally input into the first full-connection layer (FC1) to obtain a final output. The recurrent neural network layer in FIG. 2 may be Long Short-Term Memory (LSTM) or Gate Recurrent Unit (GRU). A specific parameter may be determined according to an actual situation.

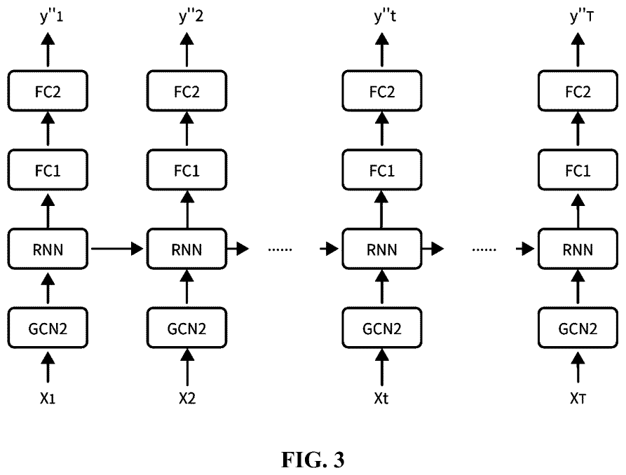

The model shown in FIG. 2 is trained based on the data of the selected source domain station. Then the weight of each parameter of the recurrent neural network layer in the trained model and the existing graph neural network layer is frozen and migrated to the target station. The migration manner is to combine a manner in which the target station is a new node with the original graph neural network layer. Moreover, a second full-connection layer FC2 is added to the model framework in FIG. 2. Then an unfrozen model parameter is fine-tuned based on the data of the target station. The final adjusted model framework (power prediction model) is shown in FIG. 3. The data input to the power prediction model is still sequence data, but the dimension is adjusted to (X¹, . . . , Xⁿ, Xⁿ⁺¹)∈ [symbol] . Moreover, each Xⁱ∈ [symbol] is the same and denotes the weather forecast data of the target station and the historical actual data of the target station. With the adoption of this migration manner and model framework, the purpose of migrating the training model based on the data of multiple source domain stations to the target station can be achieved.

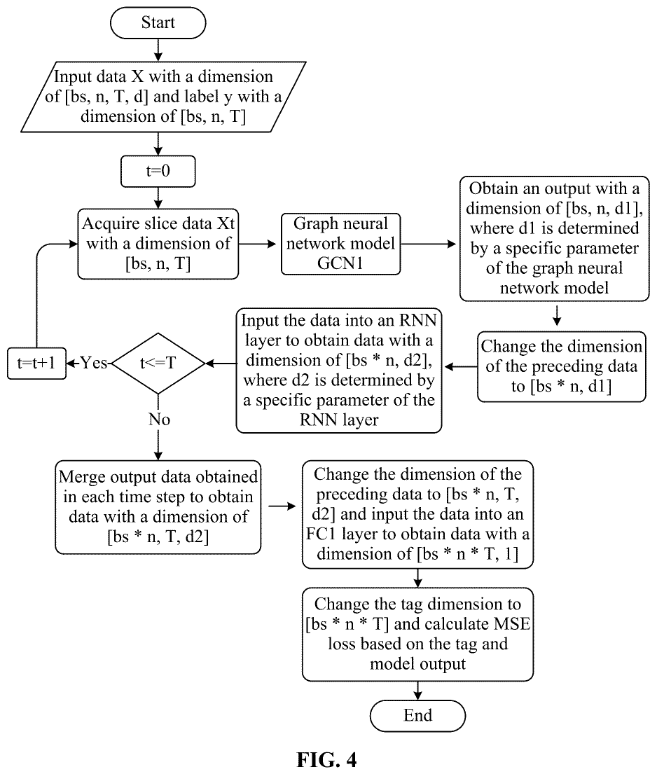

As shown in FIG. 4, training the model (graph neural network model) shown in FIG. 2 based on the data of the selected source domain station has the specific steps below.
1. The source domain station is selected, and the distance between stations is determined according to longitude and latitude coordinates of the stations.
2. The graph neural network layer is constructed based on the selected source domain station, and the edge connection state between nodes is determined.
3. The number of layers in the graph neural network layer and a parameter of the graph neural network layer are determined, and the number of layers in the recurrent neural network layer and a parameter of the recurrent neural network layer are determined.
4. The training data with a data dimension of [bs, n, T, d] is prepared, where bs denotes the data batch size, n denotes the number of source domain stations, T denotes the length of sequence data, and d denotes the number of features of input data. The operations below are performed for each time step in which t=1, 2, . . . , and T.
(1) Slice data with a dimension of [bs, n, d] is input into the graph neural network layer GCN1 to obtain an output with a dimension of [bs, n, d1], where d1 is determined by an output channel parameter of the graph neural network layer.
(2) The output dimension [bs, n, d1] in the preceding step is changed to [bs*n, d1] to be input into the recurrent neural network layer RNN to obtain data with a dimension of [bs*n, d2], where d2 is determined by a parameter of the recurrent neural network layer RNN.
(3) If the current time step t<=T, operations (1) and (2) are repeated, and the time step is increased by 1; if t>T, step 5 is proceeded to.
5. The output result obtained in step 4 is merged to obtain data with a dimension of [bs*n, T, d2], the dimension of the data is changed to [bs*n*T, d2], and then the changed data having the dimension of [bs*n*T, d2] is input into the first full-connection layer FC1 to obtain data with a dimension of [bs*n*T, 1].

6. The dimension of tag data is changed to [bs*n*T], MSE loss is calculated based on tag data and the output in step 5.

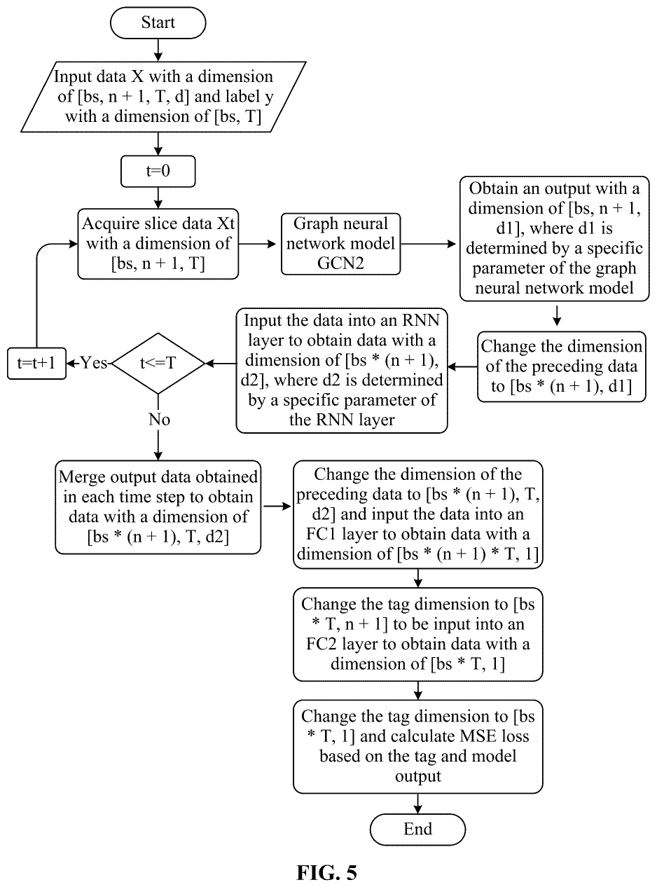

As shown in FIG. 5, after the model framework shown in FIG. 2 is trained through the data of the source domain station, each parameter of the recurrent neural network layer and the existing graph neural network layer is frozen, and then the model is migrated to the target station to fine-tune an unfrozen model parameter again. The specific steps are as below.
1. The distance between stations is determined according to longitude and latitude coordinates of the target station.
2. The target station is incorporated as a new node into the existing graph neural network layer, and an edge connection state between the target station and the existing node is determined based on the distance between the stations in step 1.
3. A second full-connection layer FC2 is added based on the model framework in FIG. 2. The number of nerves in the second full-connection layer is 1.
4. The training data with a data dimension of [bs, n+1, T, d] is prepared, where bs denotes the data batch size, n+1 denotes the number of stations, T denotes the length of sequence data, and d denotes the number of features of input data. Since the model is fine-tuned only through the data of the target station, the input data of the target station is copied (n+1) times. The operations below are performed for each time step in which t=1, 2, . . . , and T.
(1) Slice data with a dimension of [bs, n+1, d] is input into the graph neural network layer GCN2 to obtain an output with a dimension of [bs, n+1, d1], where d1 is determined by an output channel parameter of the graph neural network layer.
(2) The output dimension in the preceding step is changed to [bs*(n+1), d1] to be input into the recurrent neural network layer RNN to obtain data with a dimension of [bs*(n+1), d2], where d2 is determined by a parameter of the recurrent neural network layer RNN.
(3) If the current time step t<=T, operations (1) and (2) are repeated, and the time step is increased by 1; if t>T, step 5 is proceeded to.
5. The output result obtained in step 4 is merged to obtain data with a dimension of [bs*(n+1), T, d2], the dimension of the data is changed to [bs*(n+1)*T, d2], and then the changed data having the dimension of [bs*(n+1)*T, d2] is input into the first full-connection layer FC1 to obtain data with a dimension of [bs*(n+1)*T, 1].
6. The output obtained in step 5 is changed to data of [bs*T, n+1], and the changed data having the dimension of [bs*T, n+1] is input into the second full-connection layer FC2 to obtain data with a dimension of [bs*T, 1].
7. The dimension of tag data is changed to [bs*T], MSE loss is calculated based on tag data and the output in step 6.

Based on the data of the target station, the final power prediction model is obtained by fine-tuning the model framework (power prediction model) shown in FIG. 3 and the process shown in FIG. 5. The final power prediction model can be used for predicting the generated power of the target station in a future period of time subsequently. Since (n+1) nodes are used in the graph neural network model of the model framework shown in FIG. 3, the input data of the target station needs to be copied (n+1) times in each reasoning to obtain the input data with a dimension of [1, n+1, T, d]. The data is input into the model so as to obtain the predicted power data with a length of T.

In the method for predicting new energy power in the present application, a composite architecture fusing the graph neural network layer (GNN layer) and the recurrent neural network layer (RNN layer) is used. The GNN layer captures the spatial synergistic features of a regional meteorological field through a topological connection to model the spatial correlation (such as meteorological transmission or geographic proximity effect) between stations. The RNN layer dynamically models time sequence data and analyzes the time-varying laws of meteorological factors such as wind speed and irradiance. The dual-network coupling implements the joint analysis of spatio-temporal dependency in the meteorology-power mapping relationship and improves prediction accuracy. In the migration stage of the present application, GNN-RNN core parameters are frozen (with spatial topology modeling and time sequence feature extraction capabilities retained), and only full-connection layers are fine-tuned to adapt to features of the target station (such as the inclination angle of a photovoltaic panel and a difference between wind turbine models), resulting in a small amount of training and improving training efficiency.

The preceding technical solutions are described hereinafter with reference to the drawings and embodiments.

The present application is implemented based on the pytorch framework and the torch_geometric framework. The recurrent neural network layer uses torch.nn.LSTM or torch.nn.GRU. The graph neural network layer uses torch_geometric.nn.GCNConv.

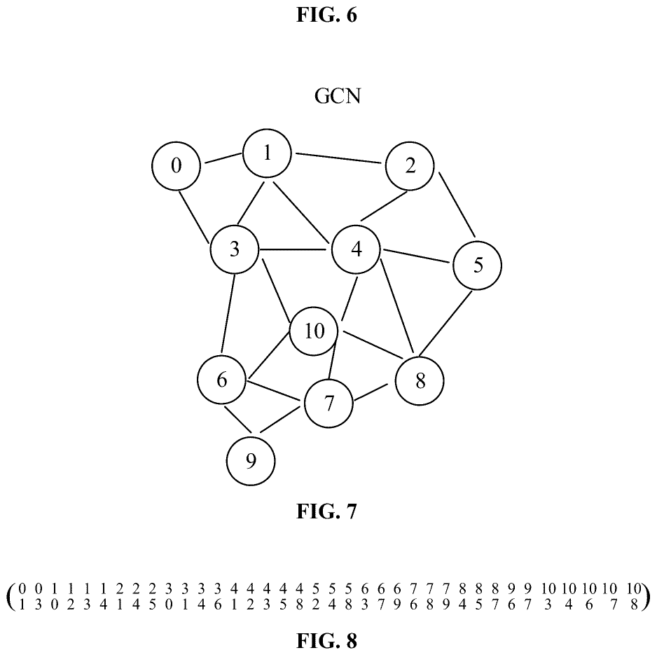

It is assumed that 10 source domain stations have been selected to train the model framework shown in FIG. 2. The connection between stations is shown in FIG. 1. Therefore, n is 10. Data input into the model is weather forecast data, specifically including forecast irradiance, forecast temperature, forecast humidity, forecast air pressure, forecast wind speed, and forecast wind direction. Therefore, d is 6. The length of sequence data is 96. Therefore, Tis 96. The time resolution of data is 15 minutes. The length of output data is 96, that is, the generated power at 96 moments in 24 hours a day is predicted based on one-day forecast data. The dimension of the input data obtained based on the date of the source domain station is [bs, 10, 96, 6]. Because the graph neural network model is adopted, it is necessary to construct an edge connection based on the connection between nodes. As shown in FIG. 6, an edge matrix is constructed based on the node connection shown in FIG. 1. The values in upper and lower rows of the matrix represent node serial numbers, and a connection exists between these two nodes. The diagram shown in FIG. 1 has a total of 16 edges, so the dimension of the created edge matrix is [2, 32]. The model shown in FIG. 2 may be trained based on the edge connection matrix in FIG. 6 and the input data.

After the model is trained based on the data of the source domain station, the model needs to be migrated to the target station and fine-tuned. For example, the target station is incorporated as the 11-th node into the existing graph neural network layer to obtain a new graph as shown in FIG. 7. As a node is newly added, the edge matrix needs to be modified. The updated edge matrix is shown in FIG. 8. Node 10 and the connection of node 10 and surrounding stations are newly added.

Each parameter of the trained recurrent neural network layer and the graph neural network layer are frozen, and the second full-connection layer FC 2 is newly added. The dimension of the input data is obtained as [bs, 11, 96, 6] based on the data of the target station. Because only the target station is used for fine-tuning model parameters, the input data of 11 nodes are all the data of the target station. That is, the input data with a dimension of [bs, 11, 96, 6] can be obtained by copying the data with a dimension of [bs, 96, 6] 11 times. The process shown in FIG. 5 is used so as to fine-tune model parameters based on the data of the target station and use the adjusted model to predict the generated power of the target station in the subsequent time.

The present application also discloses a computer program product including a computer program. When the computer program is executed by a processor, steps of the preceding method are performed. The present application also discloses a computer-readable storage medium for storing a computer program which, when executed by a processor, performs steps of the preceding method. The present application further discloses a system for predicting the generated power of a new energy station based on a recurrent graph neural network, including a memory and a processor connected to each other. The memory stores a computer program. The computer program, when executed by the processor, performs steps of the preceding method. The product, medium, and system of the present application correspond to the preceding method and also have the advantages of the preceding method.

In the present application, all or part of the processes in the method in the preceding embodiments are implemented or are completed by hardware related to computer program instructions. A computer program may be stored in one computer-readable storage medium. When the computer program is executed by a processor, steps in the preceding method embodiments may be implemented. The computer program includes computer program codes. The computer program codes may be in the form of source codes, the form of object codes, the form of an executable file, or some intermediate form. The computer-readable storage medium includes any entity or apparatus capable of carrying computer program codes, a recording medium, a USB disk, a mobile hard disk, a magnetic disk, an optical disk, a computer memory, a read-only memory (ROM), a random access memory (RAM), an electrical carrier signal, a telecommunication signal, or a software distribution medium. The memory is used for storing a computer program and/or a module. The processor implements various functions by running or executing the computer program and/or module stored in the memory and calling data stored in the memory. The memory may include a high-speed random access memory, and may also include a non-volatile memory such as a hard disk, a memory, a plug-in hard disk, a smart media card (SMC), a secure digital (SD) card, a flash card, at least one magnetic disk storage device, a flash memory device, or other volatile solid state storage devices.

What is claimed is:

1. A method for predicting generated power of a new energy station based on a recurrent graph neural network, comprising:
pre-constructing a graph neural network model, wherein the graph neural network model comprises a graph neural network layer, a recurrent neural network layer, and a first full-connection layer; and the graph neural network layer, the recurrent neural network layer, and the first full-connection layer are sequentially connected to each other;
acquiring historical weather forecast data of a target station, actual power data of the target station, historical weather forecast data of a source domain station, and actual power data of the source domain station; and training the graph neural network model based on the historical weather forecast data of the source domain station and the actual power data of the source domain station to obtain a trained graph neural network model; wherein the source domain station is a surrounding station of the target station; and
freezing a parameter weight of each network layer in the trained graph neural network model and migrating the parameter weight to the target station to obtain a power prediction model, and fine-tuning the power prediction model based on historical meteorological data of the target station and the actual power data of the target station to obtain a final power prediction model for predicting power of the target station.

2. The method for predicting the generated power of the new energy station based on the recurrent graph neural network according to claim 1, wherein freezing the parameter weight of the each network layer in the trained graph neural network model and migrating the parameter weight to the target station comprises:
determining a distance between stations according to longitude and latitude coordinates of the target station;
incorporating the target station as a new node into the graph neural network layer of the graph neural network model, and determining an edge connection state between the target station and the existing source domain station based on the distance between the stations; and
adding a second full-connection layer based on the graph neural network model to obtain the power prediction model.

3. The method for predicting the generated power of the new energy station based on the recurrent graph neural network according to claim 2, wherein fine-tuning the power prediction model based on the historical meteorological data of the target station and the actual power data of the target station comprises:
copying the historical meteorological data of the target station and the actual power data of the target station (n+1) times to be input into a graph neural network layer of the power prediction model and a recurrent neural network layer of the power prediction model to obtain an output result of the recurrent neural network layer, wherein a data dimension of the historical weather forecast data of the target station and a data dimension of the actual power data of the target station are [bs, n+1, T, d], wherein bs denotes a data batch size, n+1 denotes a number of stations, T denotes a length of sequence data, and d denotes a number of features of input data;
merging the output result of the recurrent neural network layer to obtain data with a dimension of [bs*(n+1), T, d2], changing the dimension of the data to [bs*(n+1)*T, d2], and inputting the changed data having the dimension of [bs*(n+1)*T, d2] into the first full-connection layer FC1 to obtain data with a dimension of [bs*(n+1)*T, 1];
changing the data with the output dimension of [bs*(n+1)*T, 1] to data with a dimension of [bs*T, n+1], and inputting the changed data having the dimension of [bs*T, n+1] into the second full-connection layer FC2 to obtain data with a dimension of [bs*T, 1]; and
changing a dimension of tag data to [bs*T], calculating MSE loss based on the tag data and the data with the dimension of [bs*T, 1].

4. The method for predicting the generated power of the new energy station based on the recurrent graph neural network according to claim 3, wherein copying the historical meteorological data of the target station and the actual power data of the target station (n+1) times to be input into the graph neural network layer of the power prediction model and the recurrent neural network layer of the power prediction model to obtain the output result of the recurrent neural network layer comprises:
performing following operations for each time step in which t=1, 2, . . . , and T:
inputting slice data with a dimension of [bs, n+1, d] into the graph neural network layer GCN2 to obtain an output with a dimension of [bs, n+1, d1], wherein d1 is determined by an output channel parameter of the graph neural network layer;
changing the output dimension [bs, n+1, d1] to [bs*(n+1), d1] to be input into the recurrent neural network layer to obtain data with a dimension of [bs*(n+1), d2], wherein d2 is determined by a parameter of the recurrent neural network layer RNN; and
in response to a current time step t<=T, repeating preceding operations and increasing the time step by 1; and in response to t>T, proceeding to a next step.

5. The method for predicting the generated power of the new energy station based on the recurrent graph neural network according to claim 1, wherein training the graph neural network model based on the historical weather forecast data of the source domain station and the actual power data of the source domain station comprises:
selecting the source domain station and determining the distance between the stations according to longitude and latitude coordinates of the stations, determining an edge connection state between nodes in the graph neural network layer based on the selected source domain station, determining the number of layers in the graph neural network layer and a parameter of the graph neural network layer, and determining the number of layers in the recurrent neural network layer and a parameter of the recurrent neural network layer;
inputting historical meteorological data of the source domain station and the actual power data of the source domain station into the graph neural network layer and the recurrent neural network layer to obtain an output result of the recurrent neural network layer, wherein a data dimension of the historical meteorological data of the source domain station and a data dimension of the actual power data of the source domain station are [bs, n, T, d], wherein bs denotes a data batch size, n denotes the number of source domain stations, T denotes a length of sequence data, and d denotes the number of features of input data;
merging the output result of the recurrent neural network layer to obtain data with a dimension of [bs*n, T, d2], changing the dimension of the data to [bs*n*T, d2], and inputting the changed data having the dimension of [bs*n*T, d2] into the first full-connection layer FC1 to obtain data with a dimension of [bs*n*T, 1]; and
changing a dimension of tag data to [bs*n*T], calculating MSE loss based on tag data and the data with the dimension of [bs*n*T, 1].

6. The method for predicting the generated power of the new energy station based on the recurrent graph neural network according to claim 5, wherein inputting the historical meteorological data of the source domain station and the actual power data of the source domain station into the graph neural network layer and the recurrent neural network layer to obtain the output result of the recurrent neural network layer comprises:
performing following operations for each time step in which t=1, 2, . . . , and T:
inputting slice data with a dimension of [bs, n, d] into the graph neural network layer GCN1 to obtain an output with a dimension of [bs, n, d1], wherein d1 is determined by an output channel parameter of the graph neural network layer;
changing the output dimension [bs, n, d1] to [bs*n, d1] to be input into the recurrent neural network layer RNN to obtain data with a dimension of [bs*n, d2], wherein d2 is determined by a parameter of the recurrent neural network layer RNN; and
in response to a current time step t<=T, repeating preceding operations and increasing the time step by 1; and in response to t>T, proceeding to a next step.

7. The method for predicting the generated power of the new energy station based on the recurrent graph neural network according to claim 1, wherein weather forecast data comprises forecast irradiance, forecast temperature, forecast humidity, forecast air pressure, forecast wind speed, and forecast wind direction.

8. A non-transitory computer-readable storage medium for storing a computer program which, when executed by a processor, performs steps of the method according to claim 1.

9. A system for predicting generated power of the new energy station based on the recurrent graph neural network, comprising a memory and a processor connected to each other, wherein the memory stores a computer program; and the computer program, when executed by the processor, performs steps of the method according to claim 1.
